(19) United States
(12) Patent Application Publication
(10) Pub. No.: US 2022/0351104 A1
(43) Pub. Date: Nov. 3, 2022

(54) CAPACITY MANAGEMENT FOR A FLEET ROUTING SERVICE

(71) Applicant: GoBrands, Inc., Philadelphia, PA (US)

(72) Inventor: Jatin Hasmukh Lodhia, Oakland, CA (US)

(73) Assignee: GoBrands, Inc., Philadelphia, PA (US)

(21) Appl. No.: 17/730,702

(22) Filed: Apr. 27, 2022

Related U.S. Application Data
(60) Provisional application No. 63/181,015, filed on Apr. 28, 2021.

(51) Int. Cl. G06Q 10/06

(52) U.S. Cl. CPC G06Q 10/06311

(57) ABSTRACT

A method includes, for a plurality of vehicles in a fleet of vehicles, receiving respective capacities for each of the plurality of vehicles. The respective capacity for each vehicle includes two or more capacity values, and each capacity value corresponds to a distinct capacity type. The method also includes receiving a request to complete a task that includes transporting a resource from an origin to a destination. The method further includes, in response to receiving the request, determining a capacity cost of the resource for each of the capacity types, selecting a vehicle of the fleet of vehicles to complete the task, and routing the vehicle based on the origin and destination of the task. Selecting the vehicle to complete the task includes determining whether the vehicle has enough capacity, for each of the capacity types, to transport the resource. A method of sourcing inventory is also described herein.

### TECHNICAL FIELD

The disclosed embodiments relate generally to systems and methods for customizable modeling of capacity in a fleet of vehicles, and the use of such models in dispatching for the fleet of vehicles.

### BACKGROUND

In the coming years, autonomous vehicle (AV) technology will overcome the present challenges in motion planning and control. For example, autonomous vehicles will be able to stay in lanes, follow cars, avoid pedestrians and drive like a taxi driver patrolling the streets. Autonomous vehicles will need only to be told where to go and how to get there, making route planning critical in the AV-driven world.

As developers build core autonomy technology and start to scale their fleets of vehicles for ride-sharing fleets, ride-hailing fleets, and/or delivery fleets, these developers will need effective fleet management technology. The winners and losers in this race will be determined by which companies operate the most efficient fleets with the highest vehicle utilizatio.

### SUMMARY

Effective inventory and capacity management is important in operation and management of a fleet of vehicles for providing on-demand transportation services (e.g., on-demand delivery services, ride-hail services, ride-share services). Effective inventory and transportation capacity management can lead to increased delivery speeds and more efficient vehicle utilization. Flexible modeling for inventory and capacity management allows a fleet manager who manages or operates a fleet of vehicles for fulfilling on-demand transportation services to improve transportation speed and increase vehicle utilization. Currently, on-demand transportation services require a user to identify a source from which the cargo or resources (e.g., inventory, assets from inventory, item(s) from inventory to be delivered, or passengers to be picked-up) can be obtained (e.g., sourced, picked-up). This requires some degree of knowledge (or searching) from a user who requested the transportation service (e.g., trip), and is limited by the user's knowledge of potential sources for the item. In some cases, such as when the trip request is to pick-up and drop-off (e.g., deliver) specific cargo (e.g., a specific person, a specific and unique (e.g., one of a kind) item), it is likely that the user who requested the trip can easily provide a pick-up location (e.g., source) for the specific passengers (e.g., the user himself or herself) or specific item (e.g., a watch with a specific customized engraving). However, in some cases, such as when the trip request is for delivery of an item that can be sourced from more than one location (e.g., a phone charger, a box of pasta), it may be desirable for an on-demand transportation service to automatically identify possible sources for the item and select a source that allows for fast (e.g., quick, short) delivery time or a more efficient route in order to provide such services, the on-demand transportation service requires knowledge of and/or access to inventory information of a plurality of sources.

Additionally, in order to complete a requested trip, the on-demand transportation service also must dispatch a vehicle that has enough capacity to successfully transport the cargo (e.g., passenger(s), item(s)) to a requested destination. Thus, the on-demand transportation service requires knowledge of a capacity that the cargo requires (e.g., 4 seats, or 2 large pizzas) as well as an available capacity of vehicles (that are available to complete the requested trip) in order to assign vehicles that are able to transport the requested cargo to the requested destination. In some cases, matching of the capacity that the cargo requires with an available capacity of a vehicle may be relatively straightforward, such as matching a single passenger to a car that has the capacity to transport at least one passenger from an origin to a destination (e.g., in a ride-hail scenario with no ride-sharing or ride-pooling). However, in some cases, such as when transporting more cargo with more than one capacity type (e.g., 1 large pizza and 1 small pizza, 2 large pizzas and a soda, or 1 passenger and 1 wheelchair passenger) and/or when transporting in a ride-share (or multiple delivery) situation such that the available capacity of a vehicle may change during a trip, flexible modeling methods are needed to overcome the challenge of accurately matching capacity required by cargo and an expected capacity availability of a vehicle.

To address the problem with existing techniques, the present disclosure provides systems and methods for flexible modeling of resource and vehicle capacity to improve dispatching and routing for on-demand transportation of people and on-demand delivery of goods. Some embodiments of the systems and methods described herein utilize capacity key value pairs for modeling vehicle capacity and resource key value pairs for modeling how much capacity a resource takes up. The systems and methods provide the ability to utilize vehicles of a fleet of vehicles to transport different resources that each take up a different amount of capacity and thus, allow for improved efficiency in dispatching, routing, and utilization of vehicles.

Another challenge in the field of on-demand delivery of goods (e.g., items) is the ability to source the requested goods such that acquisition and delivery of requested goods is performed efficiently. In some embodiments, a request for an item may allow for the requested item to be sourced from a plurality of possible locations (e.g., an apple may be acquired from almost any grocery store, or a phone charger may be obtained from any of a plurality of stores or even stored on a delivery vehicle itself). Thus, systems and methods are needed to efficiently source and deliver requested items in such a way that decreases delivery time, thereby improving user satisfaction as well as fleet efficiency and vehicle utilization rates.

To address the problem with existing techniques, the present disclosure provides systems and methods for determining which source, of a plurality of possible sources, to obtain requested items for delivery. Some embodiments of the systems and methods described herein utilize inventory from the plurality of possible sources and a cost model for routing the delivery vehicle to select a source for obtaining the requested items. The systems and methods allow for flexible sourcing of requested items in order to decrease delivery time, improve user satisfaction, and increase vehicle utilization rates and fleet efficiency.

In accordance with some embodiments, a method includes, for a plurality of vehicles in a fleet of vehicles, receiving (e.g., from a fleet manager) respective capacities for each of the plurality of vehicles. The respective capacity for each vehicle of the plurality of vehicles includes two or more capacity values, and each capacity value corresponds to a distinct capacity type. The method also includes receiving a request to complete a task. The task includes transporting a resource from an origin to a destination. The method further includes, in response to receiving the request: (i) determining a capacity cost of the resource for each of the capacity types; (ii) selecting (e.g., assigning) a first vehicle of the fleet of vehicles to complete the task, including determining whether the first vehicle has enough capacity, for each of the capacity types, to transport the resource; and (iii) routing the first vehicle based on the origin and destination of the task.

In accordance with some embodiments, a method includes receiving a first request to complete a first task. The task first includes delivering (e.g., transporting), by a vehicle of a fleet of vehicles, a first resource to a first destination. The method also includes, in response to receiving the first request: (i) identifying a plurality of sources for retrieving the first resource, including a fixed (e.g., stationary, not moving) location and a first vehicle of the fleet of vehicles; (ii) retrieving inventory information regarding availability of the first resource from each of the identified plurality of sources; and (iii) selecting a source of the plurality of sources based on the inventory of the first resource at the source, including selecting between at least the fixed location and the vehicle. The source is also selected based on a cost function associated with the source. The method further includes, in accordance with the selected source being the fixed location, routing a second vehicle to the fixed location (e.g., to retrieve the one or more resources) prior to routing the second vehicle from the fixed location to the destination, and in accordance with the selected source being the first vehicle, routing the first vehicle to the destination.

Some embodiments of the present disclosure provide a computer system (e.g., a server system), comprising one or more processors and memory storing one or more programs. The one or more programs store instructions that, when executed by the one or more processors, cause the computer system to perform any of the methods described herei.

Some embodiments of the present disclosure provide a non-transitory computer readable storage medium storing instructions that, when executed by a computer system having one or more processors, cause the computer system to perform any of the methods described herein.

These embodiments improve capacity modeling methods for transporting passengers (e.g., people) and goods (e.g., items). Thus, such embodiments may improve overall operation and management for the fleet of vehicles by improving the efficiency of vehicle dispatching and increasing vehicle utilization rates. These methods also improve sourcing of requested items in order to decrease delivery time and improve user satisfaction, fleet efficiency, and vehicle utilization rates.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings.

FIG. 1A illustrates capacities for different types of vehicles, in accordance with some embodiments.

FIG. 1B illustrates the capacity required by different types of resources, in accordance with some embodiments.

FIG. 1C illustrates identifying vehicles for a trip request by comparing vehicle capacity and capacity required by the resources to be transported in accordance with the trip request, in accordance with some embodiments.

FIG. 2A illustrates capacities for different types of vehicles, in accordance with some embodiments.

FIGS. 2B and 2C illustrate the capacity required by different types of resources, in accordance with some embodiments.

FIG. 2D illustrates identifying vehicles for a trip request by comparing vehicle capacity and capacity required by the resources to be transported in accordance with the trip request, in accordance with some embodiments.

FIG. 3 illustrates receiving a request for delivery of goods, in accordance with some embodiments.

FIG. 4A illustrates delivering goods from a predefined location in accordance with the request shown in FIG. 3, in accordance with some embodiments.

FIG. 4B illustrates delivering goods from a location in that is selected from a plurality of possible locations in accordance with the request shown in FIG. 3, in accordance with some embodiments.

FIG. 4C illustrates delivering goods from a vehicle that is selected from a plurality of possible vehicles in accordance with the request shown in FIG. 3, in accordance with some embodiments.

FIGS. 5A-5B are block diagrams illustrating an architecture of a vehicle routing engine, in accordance with some embodiments.

FIG. 6 is a block diagram illustrating a client-server environment, in accordance with some embodiments.

FIGS. 7A-7C illustrate a flowchart of a method for modeling vehicle capacity and resources, in accordance with some embodiments.

FIGS. 8A-8C illustrate a flowchart of a method for inventory management, in accordance with some embodiments.

### DETAILED DESCRIPTION

The systems and methods described herein improve vehicle capacity and resource matching by using a flexible modeling scheme that utilizes capacity key value pairs and resource key value pairs. The systems and methods described herein also improve inventory management by allowing for flexible inventory sourcing.

With the growth of on-demand transportation services, accurate estimates of a vehicle's capacity are important in managing efficient fleets with high vehicle utilization rates. On-demand transportation has expanded into many different fields, including but not limited to semi-private transportation (e.g., ride-share and ride-hail services), delivery of non-perishable goods (such as package delivery), and delivery of perishable goods (such as groceries and prepared meals). Thus, a method of defining capacity in a flexible manner allows a vehicle of a fleet to be used for multiple purposes.

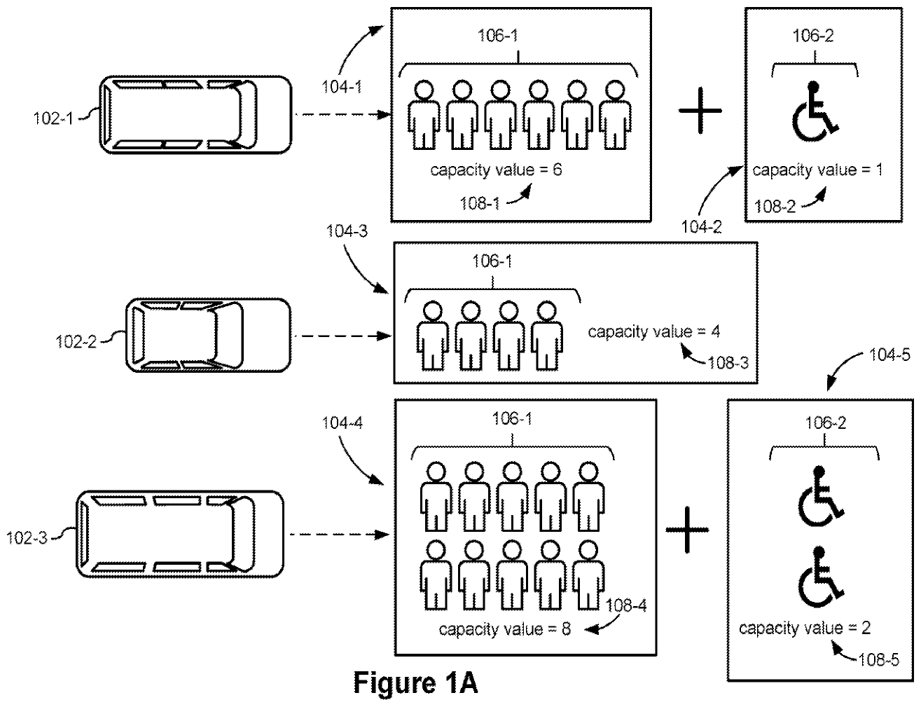

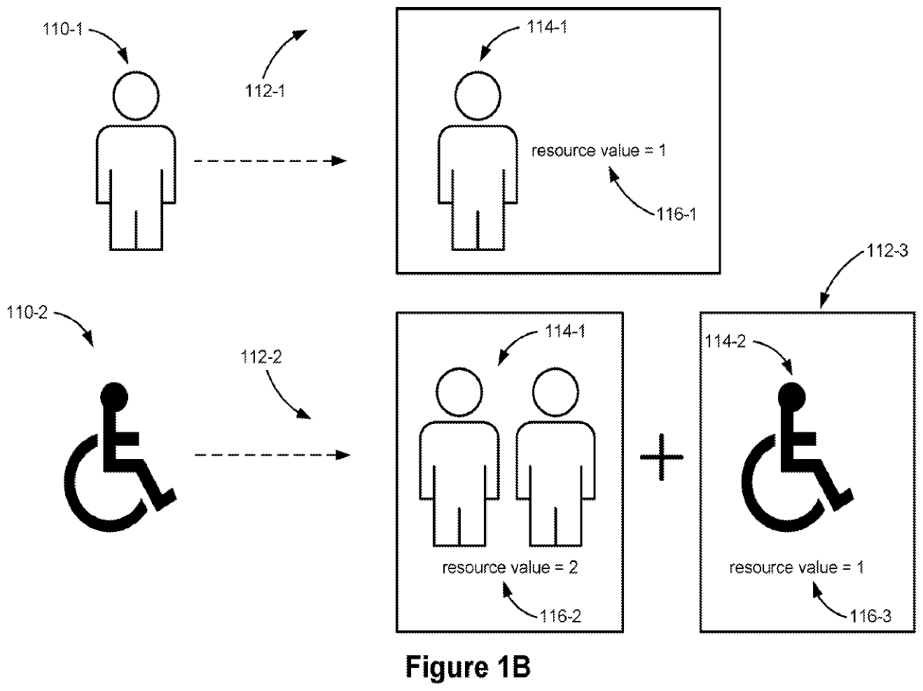

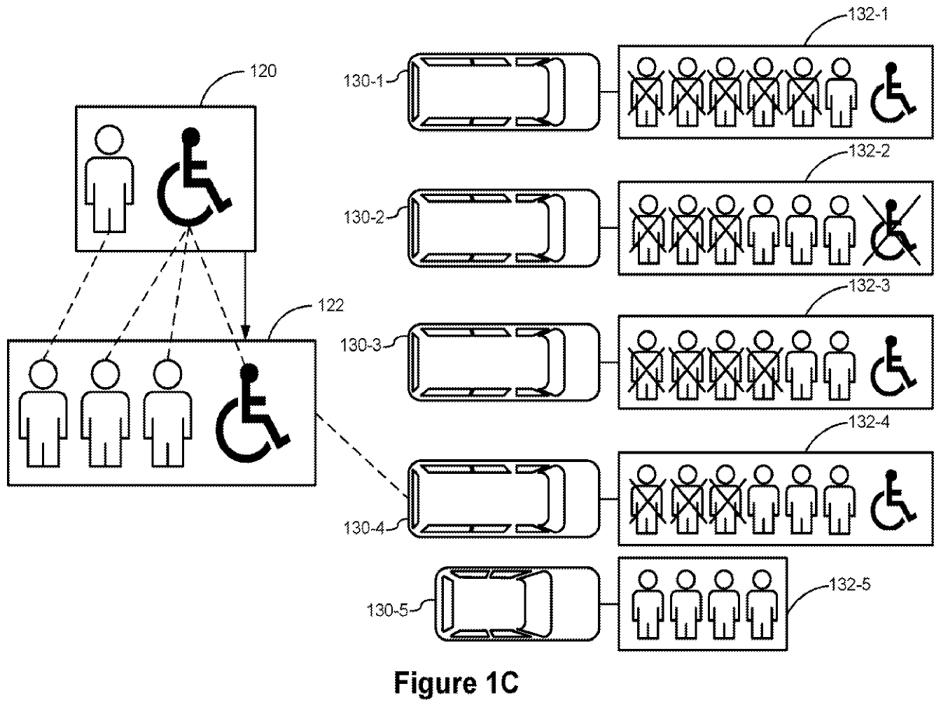

FIGS. 1A-1C provide an example of defining the capacity of different types of vehicles for transporting different types of passengers, modeling different types of passengers as having different capacity requirements, and how a dispatching service can use such methods for dispatching and routing vehicles in accordance with a user request (e.g., a trip request, an on-demand request).

FIG. 1A illustrates capacities for different types of vehicles, in accordance with some embodiments. Different vehicles may have different capacities. For example, a sedan may be able to transport a maximum of four passengers (not including the driver) and a van may be able to transport a maximum of ten passengers (not including the driver). A fleet of vehicles may include any number of different types of vehicles. For example, a fleet may include only one type of vehicle (e.g., the fleet consists of delivery vans, consists of delivery robots, consists of bicycle messengers). In another example, a fleet may be a mixed fleet that includes two or more types of vehicles. For example, a fleet may include sedans and minivans. In another example, a fleet may include delivery robots, sedans, and delivery trucks. Each vehicle has one or more capacity key value pairs 104. Each capacity key value pair 104 includes a capacity type 106 and a capacity value 108 that corresponds to the capacity type.

For example, a first vehicle 102-1 (e.g., a minivan) may have a maximum capacity to transport a total of six passengers (excluding the driver), and one of those passengers may be a passenger with a wheelchair. In practice, this means that the first vehicle 102-1 has a maximum capacity to transport six passengers or five passengers and one passenger with a wheelchair. The maximum capacity for the first vehicle 102-1 is modeled as two key value pairs 104-1 and 104-2. The first key value pair 104-1 has a first capacity type 106-1 and a first capacity value 108-1 that corresponds to the first capacity type. In this example, the first capacity type 106-1 corresponds to passengers and the first capacity value 108-1 is six (e.g., since the first vehicle 102-1 has a maximum capacity to transport six passengers). The first vehicle 102-1 also has a second capacity key value pair 104-2 that has a second capacity type 106-2 and a corresponding second capacity value 108-2. The second capacity type corresponds to wheelchairs and the second capacity value 108-6 is one (e.g., since the first vehicle 102-1 has a maximum capacity to transport one wheelchair). Thus, details regarding the first vehicle 102-1 are car type: minivan, capacity: {seat: 6}, {wheelchair: 1}).

In another example, a second vehicle 102-2 that has a second vehicle type (e.g., a sedan), that is different from the first vehicle type, has a maximum capacity to transport a total of four passengers (excluding the driver). Thus, the second vehicle 102-2 has a capacity key value pair 104-3 that includes a first capacity type 106-1 and a capacity value 108-3 that corresponds to the first capacity type. In this example, the first capacity type 106-1 corresponds to passengers and the capacity value 108-3 is four (e.g., since the second vehicle 102-2 has a maximum capacity to transport four passengers), in this example, the second vehicle 102-2 does not have any other capacity key value pairs that have a corresponding capacity value that is non-zero. In other words, the second vehicle 102-2 is not capable of (e.g., does not have capacity to) transport any other capacity types (e.g., is not capable of transporting a wheelchair). Thus, the second vehicle 102-2 only has one capacity key value pair that includes a capacity value that is non-zero. Thus, details regarding the first vehicle 102-1 are car type: sedan, capacity: {seat: 4}).

In yet another example, a third vehicle 102-3, having a third vehicle type (e.g., a van), has a maximum capacity to transport a total of eight passengers (excluding the driver), and two of those passengers may be passengers with a wheelchair. In practice, this means that the third vehicle 102-3 has a maximum capacity to transport eight passengers, seven passengers and one passenger with a wheelchair, or six passengers and two passengers with wheelchairs. Thus, the third vehicle 102-3 has a first capacity key value pair 104-4 that includes a first capacity type 106-1 corresponding to passengers, and a corresponding capacity value 108-4 of eight, signifying that the third vehicle 102-3 can transport a maximum of eight passengers. The third vehicle 102-3 also has a second capacity key value pair 104-5 that includes a second capacity type 106-2 corresponding to wheelchairs, and a corresponding capacity value 108-5 of two, signifying that the third vehicle 102-3 can transport a maximum of two wheelchairs. Thus, details regarding the first vehicle 102-1 are car type: van, capacity. {seat: 8}, {wheelchair: 2}).

FIG. 1B illustrates the amount of capacity different types of resources (e.g., cargo) require during transportation, in accordance with some embodiments. Resources are modeled using resource key value pairs that represent the amount of capacity that they require during transportation. For example, a first resource 110-1 (e.g., a passenger) includes a resource key value pair 112-1 that has a first resource type 114-1 and a first resource value 116-1 that corresponds to the first resource type 114-1. In this example, the first resource type 114-1 is passenger and the first resource value 116-1 is one, indicating that in order to transport one passenger 110-1, a vehicle must have enough capacity for one passenger (e.g., one seat). In another example, a second resource (e.g., a passenger with a wheelchair) includes two resource key value pairs 112-2 and 112-3. The resource key value pair 112-2 has a first resource type 114-1 (e.g., seat) and a resource value 116-2 that corresponds to the first resource type 114-1, and the resource key value pair 112-3 (e.g., wheelchair) has a second resource type 114-2 and a resource value 116-3 that corresponds to the second resource type 114-2. In this example, the first resource type 114-1 is a seat and the corresponding resource value 116-2 is two, and the second resource type 114-2 is a wheelchair and the corresponding resource value 116-3 is one, indicating that in order to transport one unit of the second resource 110-2 (e.g., one passenger with a wheelchair), a vehicle must have enough capacity for two seats (e.g., resource type 114-1) and one wheelchair (e.g., resource type 114-2).

FIG. 1C illustrates identifying vehicles for a trip request by comparing vehicle capacity and capacity required by the resources to be transported in accordance with the trip request, in accordance with some embodiments. A fleet of vehicles includes a plurality of vehicles that are available to complete a trip (e g, a nip request). In response to receiving a trip request to transport one or more resources, a fleet dispatching service assigns a vehicle of the fleet of vehicles to the requested trip. The fleet dispatching service must ensure that a vehicle assigned to the trip is capable of completing the trip request. For example, the vehicle must be available to receive a new trip request, and must have enough capacity to transport the one or more resources in accordance with the trip request. In order to determine whether or not a vehicle of the fleet has enough capacity to fulfill the trip request (e.g., enough capacity to carry and transport the resources), the dispatch service compares a required capacity of the resources and an available capacity (e.g., free capacity) on vehicles of the fleet. In this example, the fleet includes a plurality of vehicles 130. The fleet of vehicles may include one or more types of vehicles. For example, vehicles 130-1 to 130-4 are vehicles of a first type. As shown, each of the vehicles 130-1 to 130-4 have a maximum capacity of six passengers and one passenger with a wheelchair (as described above with respect to FIG. 1A). The fleet also includes vehicle 130-5, which is a second type of vehicle that is different from the first type of vehicle. Vehicle 130-5 has a maximum capacity of four passengers. The available capacity 132 of each vehicle is also shown, with crossed out symbols corresponding to unavailable capacity. In some embodiments, the available capacity of a vehicle is not the same as a maximum capacity of the vehicle. For example, vehicle 130-1 has a maximum capacity of six passengers and one passenger with a wheelchair. However, an available capacity 132-1 of the vehicle 130-1 shows that five of the six passenger capacities are unavailable, and that the available capacity 132-1 of the vehicle 130-1 is one passenger and one wheelchair.

A trip request 120 includes a request to transport two people, one passenger without a wheelchair and one seat with a wheelchair. The capacity required to transport the passenger is one passenger, and the capacity required to transport the passenger with a wheelchair is two seats passenger and one wheelchair (described above with respect to FIG. 1B). Thus, the required capacity 122 to complete the trip request is two passengers and one wheelchair. For example, the require passenger requirements are: 1) ID: “Jane”, required capacity. {seat: 1} and 2) ID: “John,” required capacity {seat: 2}, {wheelchair: 1}.

The dispatch service determines an available capacity for vehicles of the fleet in order to determine which vehicles have enough capacity to complete the trip request 120. In this example, the fleet manager identifies vehicle 130-5 as having enough capacity available for at least two passengers and one wheelchair (e.g., enough available capacity to fulfill the trip request 120). All the other vehicles shown (e.g., vehicles 130-1, 130-2, 130-4, and 130-5) do not have enough available capacity to fulfill the trip request 120.

In some embodiments, the available capacity 132 (e.g., free capacity) of a vehicle 130 may correspond to a current available capacity (e.g., an available capacity at the present time or present moment). In some embodiments, the available capacity 132 of a vehicle 130 may correspond to a predicted available capacity of the vehicle 130 at a predefined time (e.g., a time in the future). For example, if the trip request 120 is a request to be fulfilled at a predefined time in the future (e.g., two hours from now, thirty minutes from a present time, at 5:30 pm), the dispatch service will consider the predicted available capacity of each vehicle at or around the predefined time (e.g., at 5:30 pm or 10 minutes prior to 5:30 pm) when identifying vehicles that can be assigned to the trip request 120. In another example, the dispatch service receives information that allows the dispatch service to predict the available capacity 132 of a vehicle 130 by the time the vehicle 130 would arrive to pick up the passengers in accordance with the trip request 120. For example, vehicle 1304 may currently (e.g., at a present time) have six passengers and thus, does not have enough available capacity, at the present time, to fulfill the trip request 120. However, the dispatch service may receive information (e.g., from a routing engine) that the vehicle 130-4 is one block away from dropping off three of the six passengers and thus, by the time the vehicle 130-4 is routed to an origin (e.g., pick-up location) for the trip request 120, the vehicle 1304 will have enough available capacity 132-4 to transport the passengers (e.g., one passenger and one passenger with a wheelchair) and complete the trip request 120.

Once the dispatch service has identified one or more vehicles of the fleet (e.g., at least one vehicle 130 of the fleet of vehicles) that has an available capacity that meets or exceeds the required capacity for the trip request 120, the dispatch service selects a vehicle from the identified one or more vehicles to be assigned to the trip request 120. The dispatch service selects the vehicle based at least in part on a cost model (e.g., cost function) that is used to determine a cost of assigning and routing vehicles for trips. In some embodiments, the dispatch service selects the vehicle based at least in part on a total travel distance from a current position of the vehicle to an origin (e.g. pick-up location) of the trip request 120 and/or a total travel distance from the origin to a destination (e.g., drop-off location) of the trip request 120. In some embodiments, the dispatch service selects the vehicle based at least in part on a total travel time from a current position of the vehicle to an origin (e.g. pick-up location) of the trip request 120 and/or from the origin to a destination (e.g., drop-off location) of the trip request 120. In some embodiments, dispatch service selects the vehicle based at least in part on total trip completion time.

In some embodiments, the available capacity may be determined based at least in part on expected loads during the trip. For example, for ride-share trips where part of the trip is already scheduled or dispatched, an available capacity for a second trip is determined based on the number of passengers being picked up at a first pick-up location corresponding to a first trip. In another example, a vehicle may be assigned to transport two resources from two different pick-up locations to two different drop off locations. In the case where the second resource is picked up prior to dropping off the first resource, the available capacity of the vehicle for transporting the second resource is determined based in part on the capacity requirement of the first resource.

Thus, the methods of modeling and matching capacity of vehicles and resources can be used for a wide-variety of applications, including but not limited to on-demand transportation services such as ride-share and ride-hail services, as well as scheduled transportation services (such as a limousine or van booking service).

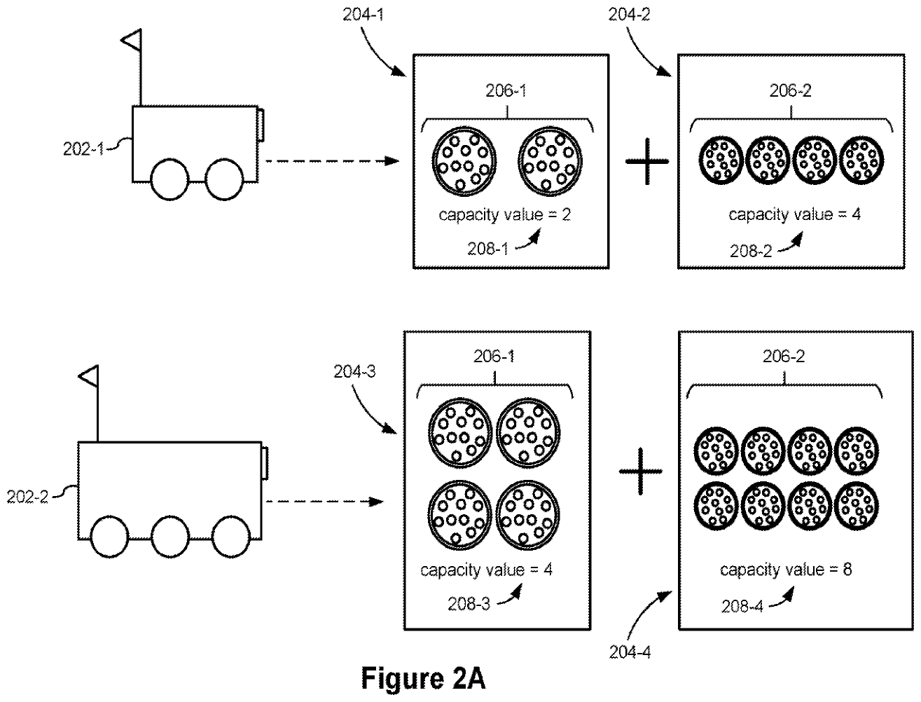

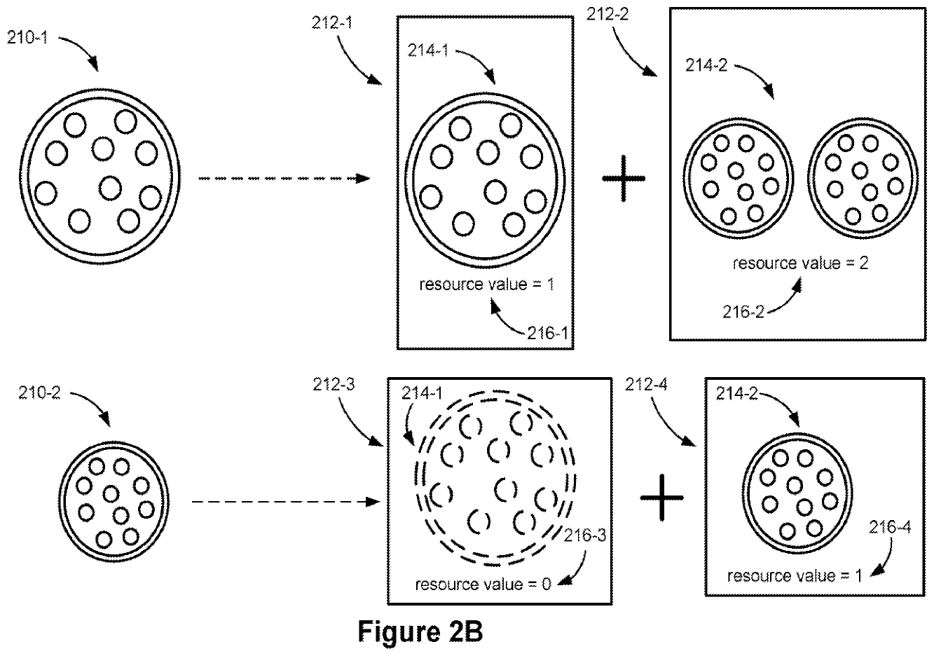

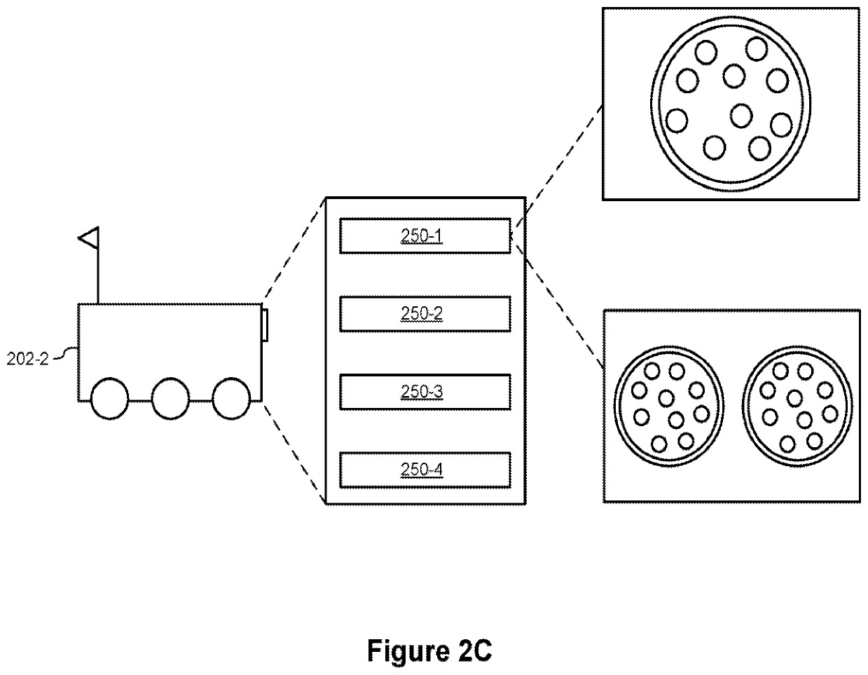

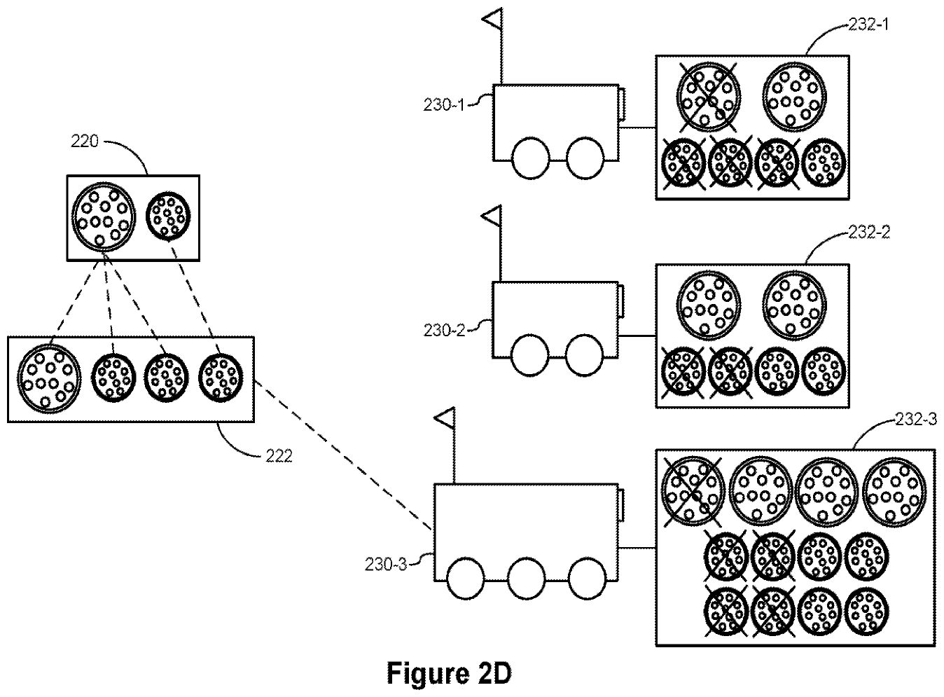

FIGS. 2A-2C provide an example of defining the capacity of different types of vehicles for transporting different types of items, modeling different types of items as having different capacity requirements, and how a dispatching service can use such methods for dispatching and routing vehicles in accordance with a user request (e.g., a trip request, an on-demand request).

FIG. 2A illustrates capacities for different types of vehicles, in accordance with some embodiments. As described above, vehicles of different vehicle types may have different capacity values for different capacity types. For example, a small delivery robot may be able to transport a maximum of two large pizzas while a delivery van may be able to transport a maximum of one hundred pizzas. The maximum capacity for each vehicle can be defined using capacity key value pairs. For example, a first vehicle 202-1 having a first vehicle type (e.g., a small delivery robot) has a first capacity key value pair 204-1 that includes a first capacity type 206-1 and corresponding capacity value 208-1, and a second capacity key value pair 204-2 that includes a second capacity type 206-2 and corresponding capacity value 208-2. The first capacity type 206-1 is a large pizza and the capacity value 208-1 corresponding to the first capacity type 206-1 (e.g., large pizza) is two, indicating that the vehicle 202-1 can carry a maximum of two large pizzas. The second capacity type 206-2 is a small pizza and the capacity value 208-2 corresponding to the second capacity type 206-2 (e.g., small pizza) is four, indicating that the vehicle 202-1 can carry a maximum of four large pizzas. In practice, the vehicle 202-1 (e.g., the small delivery robot 202-1) can transport two large pizzas, four small pizzas, or some combination of large and small pizzas (based on the capacity that large pizzas and small pizzas require), but cannot transport two large pizzas and four small pizzas at the same time.

In another example, a second vehicle 202-2 having a second vehicle type (e.g., a large delivery robot), that is different from the first vehicle type, has two capacity key value pairs 204-3 and 204-4. The capacity key value pair 204-3 includes the first capacity type 206-1 corresponding to large pizzas, and a corresponding capacity value 208-3 of four, indicating that the second vehicle 202-2 has a maximum capacity to transport four large pizzas. The capacity key value pair 204-4 includes the second capacity type 206-2 corresponding to small pizzas, and a corresponding capacity value 208-4 of eight, indicating that the second vehicle 202-2 has a maximum capacity to transport eight small pizzas. Thus, the second vehicle 202-2 is able to, at maximum capacity, transport four large pizzas, eight small pizzas, or any combination thereof (depending on the capacity that large pizzas and small pizzas require). However, the second vehicle 202-2 (e.g., the large delivery robot 202-2) cannot simultaneously transport four large pizzas and eight small pizzas.

Different resources may also take up space for more than one resource type. For example, a large pizza may have a capacity requirement of one large pizza as well as a capacity requirement of two small pizzas, indicating that when a large pizza is placed into a vehicle, it takes away (e.g., removes) capacity to carry two small pizzas from the vehicle.

FIGS. 2B and 2C illustrate the amount of capacity different types of resources require during transportation, in accordance with some embodiments. Each resource is modeled using resource key value pairs that represent the amount of capacity that the resource requires during transportation.

FIG. 2B illustrates an example where a first resource 210-1 (e.g., a large pizza) includes two resource key value pairs 212-1 and 212-2. The resource key value pair 212-1 has a first resource type 214-1 and a first resource value 216-1 that corresponds to the first resource type 214-1. In this example, the first resource type 214-1 is a large pizza and the first resource value 216-1 is one, indicating that in order to transport one unit of the first resource 210-1 (e.g., one large pizza), a vehicle must have enough capacity for one large pizza. The second resource type 214-2 is a small pizza and the first resource value 216-1 is two, indicating that in order to transport one unit of the first resource 210-1 (e.g., one large pizza), a vehicle must have enough capacity for two small pizzas. Thus, when transporting a large pizza, the vehicle must have capacity available for one large pizza and two small pizzas in order to be able to transport one large pizza.

In another example, a second resource (e.g., a small pizza) includes two resource key value pairs 212-3 and 212-4. The resource key value pair 212-2 has a first resource type 214-1 and a resource value 216-3 that corresponds to the first resource type 214-1, and the resource key value pair 212-4 has a second resource type 214-2 and a resource value 216-4 that corresponds to the second resource type 214-2. The first resource type 214-1 is a large pizza and the corresponding resource value 216-3 is zero, and the second resource type 214-2 is a small pizza and the corresponding resource value 216-4 is one, indicating that in order to transport one unit of the second resource 110-2 (e.g., one small pizza), a vehicle must have enough capacity for one small pizza (e.g., resource type 214-2).

FIG. 2C shows an example of how the required capacity of a resource is used in practice. In this example, a large delivery robot 202-2 includes four compartments 250 (e.g., compartments 25-1 to 250-4) for holding pizzas. Each compartment has enough space to hold either one large pizza or two small pizzas. For example, when a small pizza is added to one of the compartments 250, the capacity of the delivery robot 202-2 is reduced such that it can no longer carry a large pizza in that compartment 250, but can still carry a second small pizza in the same compartment 250. This is reflected in key value pairs 212-3 and 212-4 shown in FIG. 2B. Similarly, if a large pizza is added to a compartment 250, the capacity of the delivery robot 202-2 is reduced such that it can no longer carry another large pizza or another small pizza in that compartment 250. This is reflected in key value pairs 212-1 and 212-2 shown in FIG. 2B.

FIG. 2D illustrates identifying vehicles for a trip request by comparing vehicle capacity and capacity required by the resources to be transported in accordance with the trip request, in accordance with some embodiments. In the example shown in FIG. 2C, a fleet of delivery robots are available to complete a trip (e.g., a trip request). In response to receiving a trip request to transport one or more resources, a fleet dispatching service assigns a delivery robot (e.g., a vehicle) of the fleet to the requested trip. The fleet dispatching service must determine (e.g., ensure, confirm) that a delivery robot assigned to the trip is capable of completing the trip request. For example, the delivery robot must be available to receive a new trip request, and must have enough capacity to transport the one or more resources (e.g., cargo) in accordance with the trip request. In order to determine whether or not a delivery robot of the fleet has enough capacity to fulfill the trip request (e.g., enough capacity to carry and transport the resources), the dispatch service compares a required capacity of the resources and an available capacity (e.g., free capacity) of delivery robots of the fleet. In this example, the fleet includes a plurality of delivery robots 230. The fleet may include one or more types of delivery robot. For example, delivery robots 230-1 and 230-2 are small delivery robots that have a maximum capacity of two large pizzas or four small pizzas (as described above with respect to FIG. 2A). The fleet also includes delivery robot 230-3, which is a large delivery robot that has a maximum capacity of four large pizzas or eight small pizzas. The available capacity 232 of each delivery robot is also shown, with crossed out symbols corresponding to unavailable capacity. In some embodiments, the available capacity of a delivery robot is not the same as a maximum capacity of the delivery robot. For example, delivery robot 230-1 has a maximum capacity of two large pizzas and four small pizzas. However, an available capacity 232-1 of the delivery robot 230-1 shows that the delivery robot 230-1 is currently occupied by a large pizza (which takes up capacity for 1 large pizza and 2 large pizzas) and a small pizza and thus, is not available to carry or transport any more pizzas of any size (since a large pizza requires capacity for one large pizza and two small pizzas and a small pizza requires capacity for one small pizza and one large pizza).

A trip request 220 includes a request to transport one large pizza and one small pizza. The capacity required to transport the large pizza is one large pizza and two small pizzas, and the capacity required to transport the small pizza is one small pizza (described above with respect to FIG. 2B). Thus, the required capacity 222 to complete the trip request is two large pizzas and three small pizzas. The dispatch service determines an available capacity for vehicles of the fleet in order to determine which vehicles have enough capacity to complete the trip request 220. In this example, the fleet manager identifies delivery robot 230-5 as having enough capacity available for the large pizza and the small pizza. All the other vehicles shown (e.g., delivery robots 230-1 and 230-2) do not have enough available capacity to fulfill the trip request 220.

While the examples in FIGS. 1A-1C and 2A-2D each focus on a specific set of related resources to be transported (e.g., passengers, pizzas), the capacity and resource modeling described above with respect to FIGS. 1A-1C and 2A-2D can be combined with one another or with any number of other capacity and resource models in other fields. For example, a vehicle of the fleet of vehicles may have any of: a capacity key value pair corresponding to a passenger capacity, a capacity key value pair corresponding to a luggage capacity, a capacity key value pair corresponding to a pizza capacity, a capacity key value pair corresponding to a large package capacity, and a capacity key value pair corresponding to a small package capacity. Thus, the vehicle may be able to complete multiple trips at once, such as transporting a passenger while also transporting one or more packages.

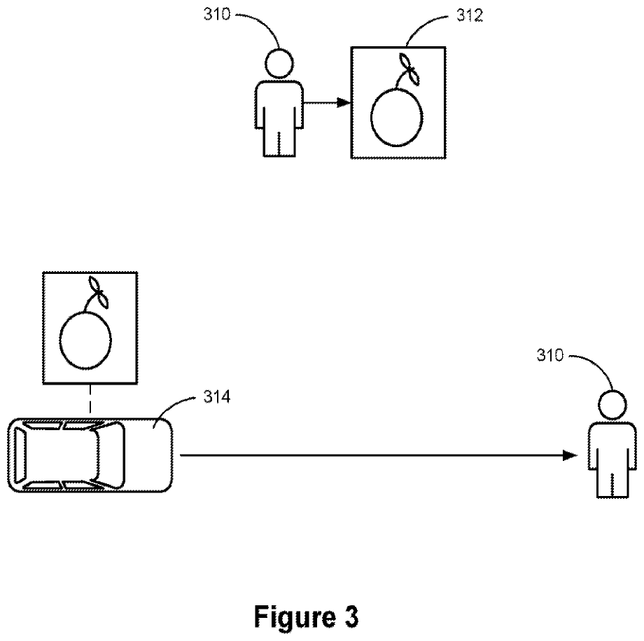

FIG. 3 illustrates receiving a request 312 for delivery of goods, in accordance with some embodiments. The request 312 may be received from a user 310. The request 312 includes one or more items to be delivered to a location for delivery (e.g., a drop-off location, a destination). In the example shown in FIG. 3, a request 312 for delivery of one or more items is received by a fleet dispatching service. In response to receiving the user request 312, the fleet dispatching service selects a vehicle 314 from a fleet of vehicles for delivery of the requested items in accordance with the request 312.

In some embodiments, the request may include information regarding where each of the one or more items should be acquired (e.g., picked-up). For example, a request 312 includes a request to pick up flood from a specific restaurant called Yummy Chicken that is located at 123 Superior Avenue in Cleveland, Ohio. In another example, a request 312 includes a request to pick up grocery items at a nearby grocery store. The request 312 may, in some cases, specify an exact grocery store from which to obtain the items, such as Good Grocers on 1122 California Street in Palo Alto, Calif. Alternatively, the request 312 may allow flexibility with regard to where the items are obtained. For example, the request 312 may specify one or more characteristics regarding which locations the requested items may be obtained, such as “any grocery store that is within 10 miles of the delivery location” or “any Good Grocer store” The request 312 may also allow the vehicle to complete the request 312 by obtaining the requested items from any location(s). Thus, requested items can be obtained from different types of sources, such as a specific (e.g., specified, predefined) location, a warehouse of a plurality of possible warehouses (e.g., a Good Grocer store selected from a plurality of Good Grocer stores), and a vehicle (e.g., the vehicle dispatched to fulfill the trip request).

In some embodiments, the requested items may be obtained (e.g., sourced) from a fixed location (e.g., a stationary or non-moving location, such as a building at a fixed address) or from a mobile location (e.g., a movable location or a location in transit, such as a vehicle, car, van, or delivery robot).

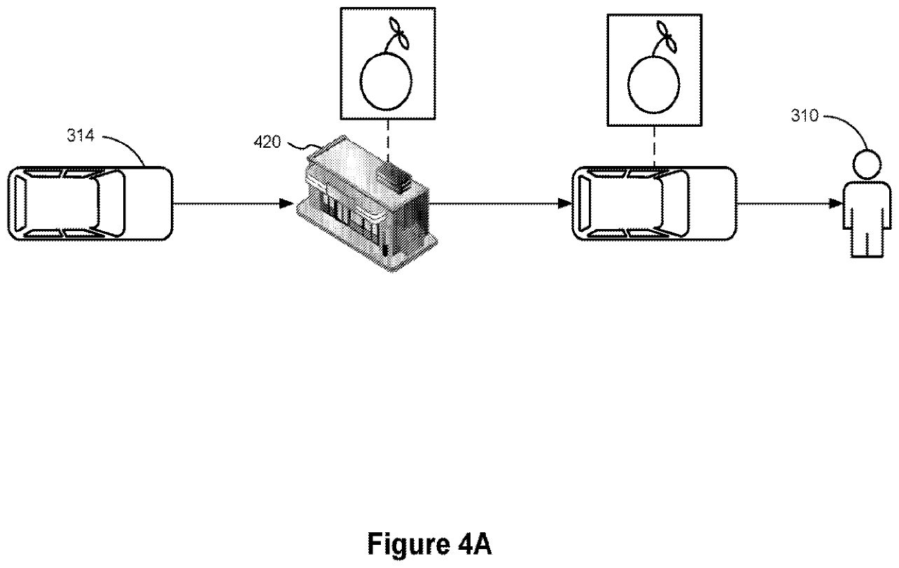

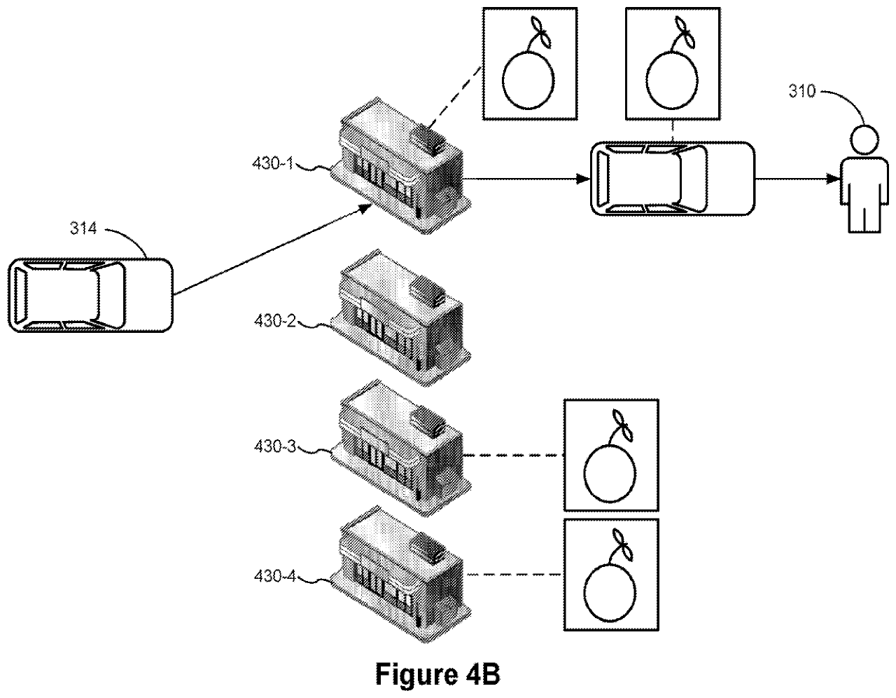

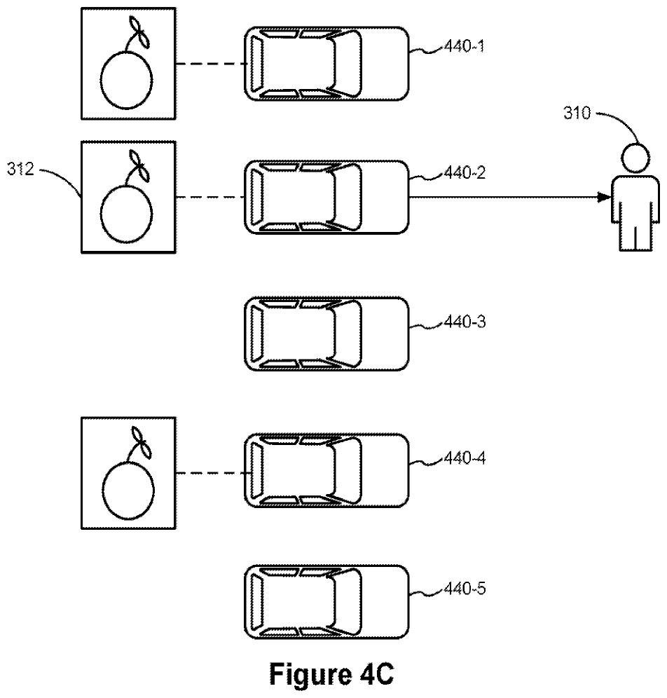

For example, the request 312 may include a request to deliver groceries (e.g., oranges) to the user 310. The groceries may be obtained from a specific grocery store, from a grocery store that is selected from a plurality of grocery stores, or from a vehicle of the fleet. FIGS. 4A-4C illustrate examples of selecting a source from which to obtain requested items (e.g., the groceries, the orange) and fulfilling the request.

FIG. 4A illustrates delivering goods from a predefined location 420 in accordance with the request shown in FIG. 3, in accordance with some embodiments. In this example, a vehicle 314 of a fleet of vehicles that is assigned to the trip request 312 is routed to a specific location 420 (e.g., Good (Grocers on 1122 California Street in Palo Alto, Calif.) to obtain the requested items. After obtaining the requested items from the specific location 420, the vehicle 314 is routed to the destination (in this example, to the user 310).

FIG. 4B illustrates delivering goods from a location 430-1 that is selected from a plurality of possible locations 430 (e.g., locations 430-1 through 430-4) in accordance with the request shown in FIG. 3, in accordance with some embodiments. In this example, the requested items can be obtained from one of a plurality of locations 430-1 through 430-4 (e.g., a grocery store of a plurality of grocery stores). A vehicle 314 of a fleet of vehicles that is assigned to the trip request 312 is routed to a location (in this example, location 430-1) that is selected from the plurality of possible locations 430 to obtain the requested items. The selected location 430-1 is selected (e.g., by a fleet dispatch service) based at least in part on the inventory available at each of the plurality of locations. The selected location 430-1 is also selected based in part on a cost factor for routing the vehicle 314. In some embodiments, the cost factor is determined based on a total travel distance. In some embodiments, the cost factor is determined based on a total travel time. In some embodiments, the cost factor is determined based on route restrictions (e.g., travel on toll roads are prohibited) and/or maneuver restrictions (e.g., no unprotected left-hand turns). After obtaining the requested items from the specific location 420, the vehicle 314 is routed to the destination (in this example, to the user 310) to deliver the requested items.

FIG. 4C illustrates delivering goods from a vehicle 440-2 that is selected from a plurality of possible vehicles 440 (e.g., vehicles 440-1 through 440-5) in accordance with the request shown in FIG. 3, in accordance with some embodiments.

In this example, the requested items can be obtained from one of a plurality of vehicles 440-1 through 440-5 of the fleet (e.g., a vehicle of the fleet of vehicles). In some embodiments, vehicles of a fleet may carry one or more commonly requested items in anticipation that the fleet may receive a request to deliver such items. For example, a fleet of delivery trucks may include, as part of the delivery truck's inventory, one or more phone chargers since they are a commonly requested item. By including commonly requested items on vehicles of the fleet, the fleet may be able to predict and meet demand at increased speed and shortened delivery times thereby improving fleet efficiency and user satisfaction.

In the example shown in FIG. 4C, vehicles 440-1, 440-2, and 440-4 of the fleet have inventory onboard to fulfill the trip request. Thus, any of vehicles 440-1, 440-2, and 440-4 can be routed directly from its current location to the destination (e.g., to the user) to deliver the requested items. In this example, vehicle 440-2 is selected from 440-1, 440-2, and 440-4 to fulfill the request 312. Vehicle 440-2 is selected based at least in part on its inventory (e.g., it has the requested items in stock). In some embodiments, vehicle 440-2 is selected based on a total travel time and/or a total travel distance to the destination. For example, while any of vehicles 440-1, 440-2, and 440-4 can fulfill the request 312, vehicle 440-2 may be located closer to the destination corresponding to the trip request 312 compared to vehicles 440-1 and 440-4. In another example, vehicle 440-2 may have a shorter travel time to the destination corresponding to the trip request 312 compared to vehicles 440-1 and 440-4.

The trip request 312 (described with respect to FIG. 3) can be fulfilled by obtaining requested items from any of the sources described with respect to FIGS. 4A-4B. Sourcing requested items requires a knowledge of the inventory at each location, and the dispatching of vehicles to fulfill the request requires knowledge of the available vehicle capacity and capacity requirements of the requested items (e.g., resources) as described above with respect to FIGS. 1A-1C and 2A-2D.

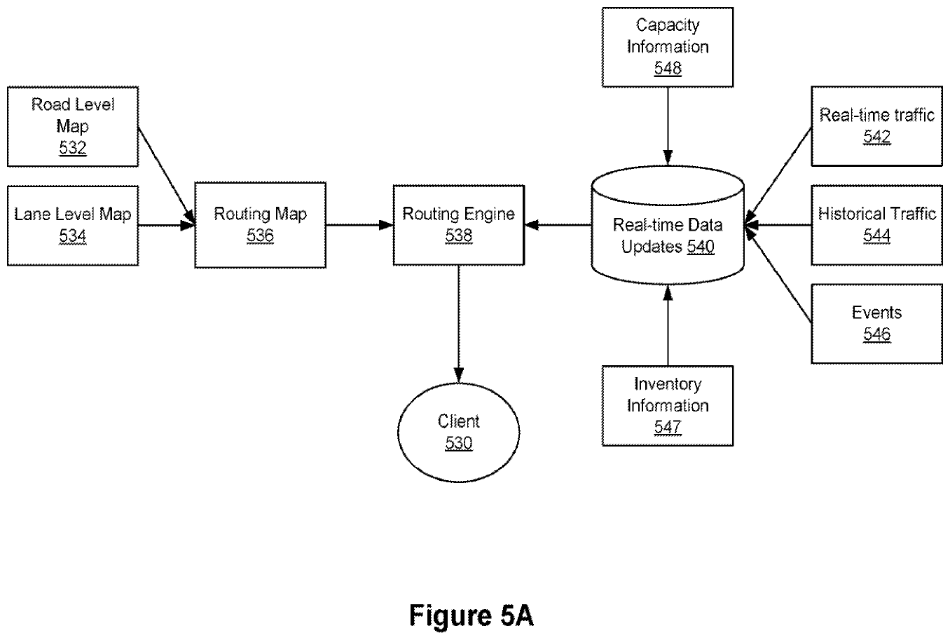

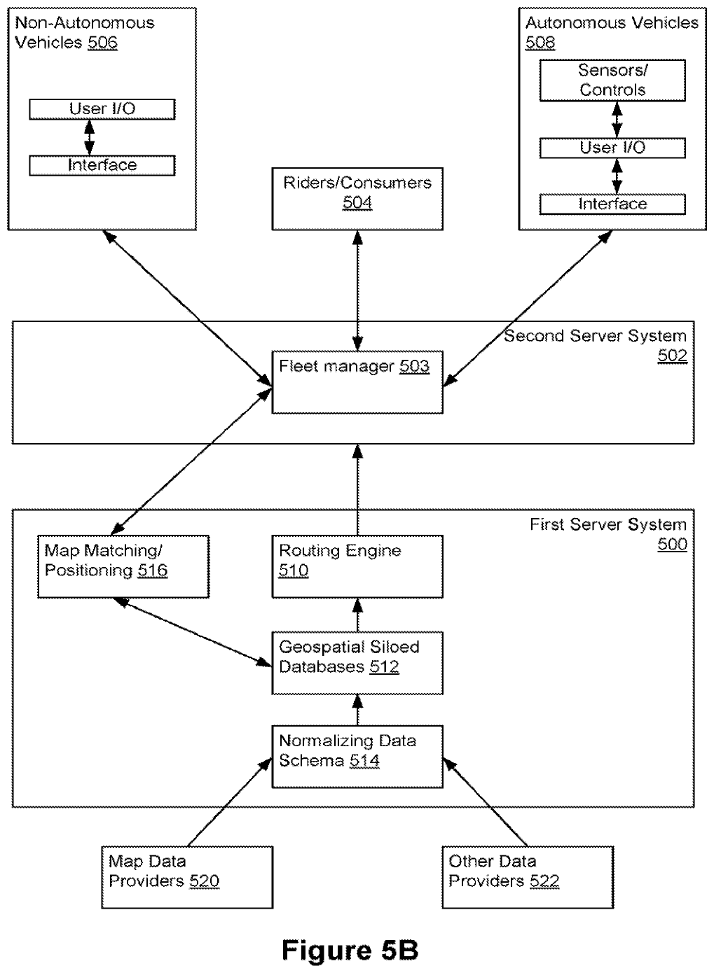

FIGS. 5A-5B are block diagrams illustrating an architecture of a vehicle routing engine, in accordance with some embodiments. For example, the client 530 is the vehicle (e.g., an autonomous vehicle or an electronic device associated with the autonomous vehicle, a non-autonomous vehicle, a tele-operated vehicle such as a delivery robot) to be routed.

Real-time data updates 540 include a server system that receives and/or tracks real-time traffic 542, historical traffic 544, Events 546, and capacity information 548 and processes and forwards the traffic and events to Routing Engine 538, such that routing engine 538 can create and/or update a route for client 530. In some embodiments, the inventory information 547 (e.g., information regarding available inventory at different locations or on vehicles of the fleet) are also provided to the routing engine 538.

The Routing Engine 538 also uses information received from routing map 536 (which may include information from a road level map 532 and/or a lane level map 534) to create/update the route for client 530.

FIG. 5B illustrates another exemplary architecture (e.g., a so-called “stack”) for a fleet of vehicles. The features of the exemplary architecture shown in FIG. 5B may optionally complement, replace, or be combined with the features of the architecture described with respect to FIG. 5A. In some embodiments, the fleet of vehicles is a mixed fleet of vehicles including autonomous vehicles (e.g., autonomous vehicles 508 including autonomous delivery robots) and non-autonomous vehicles (e.g., non-autonomous vehicles 506 including tele-operated delivery robots). In some circumstances, a fleet includes a mix of different vehicle types (e.g., automobiles, bicycles, scooters, and/or delivery robots). In some circumstances, the fleet provides services to riders (e.g., riders/consumers 504) by transporting riders from a first location to a second location. In some circumstances, the fleet provides services to other consumers, e.g., by delivering items to the consumers (e.g., delivering meals from restaurants, delivering packages from retail stores).

To facilitate the provision of these services using a mixed fleet of vehicles, the stack includes a first server system 500 that provides fleet management services and routing information. The first server system 500 includes one or more processors (e.g., CPUs) and memory storing instructions for the modules described with reference to the first server system (e.g., the map matching/positioning module 516, the routing engine 510, the geospatial siloed databases 512, and the normalizing data schema 514). The first server system 500 interfaces with a fleet manager 503 on a second server system 502. In the exemplary architecture shown in the figure, the second server system 502 acts as a client of the first server system 500, while riders, consumers (e.g., riders/consumers 504), and vehicles (e.g., non-autonomous vehicles 506 and/or autonomous vehicles 508) act as clients of the second server system 502.

In some embodiments, the second server system 502 is a separate and distinct server system from the first server system 500. The second server system 502 includes one or more processors (e.g., CPUs) and memory storing instructions for the modules described with reference to the second server system 502 (e.g., the fleet manager 503). The instructions are executed by the one or more processors. In some circumstances, the fleet manager 503 is one of a plurality of fleet managers serviced by the first server system 500. For example, the fleet manager 503 may be a fleet manager for a specific company's fleet, and the first server system 500 may provide services to multiple companies' fleets.

The first server system 500 includes a routing engine 510 that provides routes, distances, and estimated times of arrival for autonomous vehicles 508 and non-autonomous vehicles 506. In some embodiments, a different instance of the routing engine is instantiated for each fleet.

The first server system includes one or more geospatial siloed databases 512 storing geospatial data (e.g., data stored with a corresponding geographical location, such as latitude and longitude). The geospatial siloed databases 512 include map data received from map data providers 520 (e.g., data such as streets locations/geometries, street names). An example of a Map Data Provider is OpenStreetMap. In some embodiments, the geospatial data further includes “high definition” data such as lane-level data (e.g., lane locations/geometries, information about which maneuvers are permitted from which lanes) received from the map data providers 520. The geospatial data further includes data from other data providers 522, such as information received from municipalities about construction and road closures, real-time data, traffic data and other data. In addition, the geospatial siloed databases 512 store locations (e.g., map matched locations) of the vehicles in the various fleets.

In some embodiments, the geospatial siloed databases 512 store a plurality of distinct instances of data covering the same geographical region. For example, the geospatial siloed databases 512 store multiple maps (e.g., with geospatial data overlaid on those maps) covering the same region. In some circumstances, the different maps will include data appropriate to a specific fleet's vehicles (e.g., a fleet will include autonomous vehicles and delivery bots, and the geospatial siloed databases 512 will store one or more maps with information appropriate to the fleet's vehicle types). Some instances of the map may be public to any client (e.g., any fleet manager), while other versions of the map may be private to certain clients (e.g., certain fleet managers). For example, a respective fleet may license data from a respective HD map data provider. The data provided by the respective HD map data provider are thus siloed and private to the respective fleet's fleet manager (e.g., fleet manager 503).

The first server system 500 further includes a map matching/positioning module 516 that matches location data received from vehicles to a map location (e.g., a location of a map stored in the geospatial siloed databases 512). For example, some vehicles generate location data (e.g., GPS data or data from another positioning system, such as GLONASS, Galileo, or BeiDou). In some circumstances, this data is noisy and may place the vehicle away from its actual location, e.g., on a sidewalk or in a building. The map matching/positioning module 516 receives the location data from a respective vehicle (e.g., through the fleet manager 503, which interfaces with the first server system 500), matches the noisy location data to a probable road location and/or lane location and updates the “map matched” location of the vehicle in the geospatial siloed databases 512 (e.g., updates the matched position). In addition, the map matched position is provided to the fleet manager 503 for various purposes (e.g., monitoring the fleet).

As noted above, the stack includes a second server system 502, optionally distinct and separate from the first server system 500. The second server system 360 includes the fleet manager 503, which acts as a client of the first server system 500 (e.g., a client of the routing engine). The fleet manager 503 dispatches vehicles (e.g., non-autonomous vehicles 506 and/or autonomous vehicles 508), assigns routes to vehicles, and assigns staging locations to vehicles within its corresponding fleet (e.g., using information and routes provided by the routing engine). In addition, the fleet manager 503 interfaces with riders/consumers 504 (e.g., via a mobile application on the rider's smartphone or other device). The fleet manager 503 provides information such as estimated times of arrival (ETAs), estimated travel times, travel distances, and trip costs to the riders/consumers 504 via their mobile devices. In some embodiments, the fleet manager 503 also receives data such as vehicle positions (e.g., location, including optionally lane-specific location and orientation (e.g., which way the vehicle is pointing)) from the individual vehicles.

In some embodiments, an autonomous vehicle includes an AV platform which serves as an operating system and framework for the autonomous functionality of the autonomous vehicle. The autonomous vehicle includes one or more processors (e.g., CPUs) and memory storing instructions for the modules described with reference to the autonomous vehicle (e.g., the interface module, the AV platform, drivers for the sensors/controls). The instructions are executed by the one or more processors. An example of an AV platform is the open source Robotics Operating System. The fleet manager (e.g., fleet manager 503) interacts with the autonomous vehicles (e.g., autonomous vehicles 508) through an interface module, which is a module that runs on the AV platform to provide routes to the AV platform and receive data from the autonomous vehicle's sensors. For example, in some circumstances, the interface module is provided by the developer of the routing engine to act as a liaison between the first server system and the robotics of the autonomous vehicle. The AV platform receives sensor data from the autonomous vehicles sensor's and, in some circumstances, makes the sensor data available to the fleet manager, which can make the sensor data available further down the stack, for example, to the map matching/position module. In some embodiments, the AV platform sends commands to the autonomous vehicle's controls (e.g., acceleration commands, breaking commands, turning commands, etc.) through a drive-by-wire system.

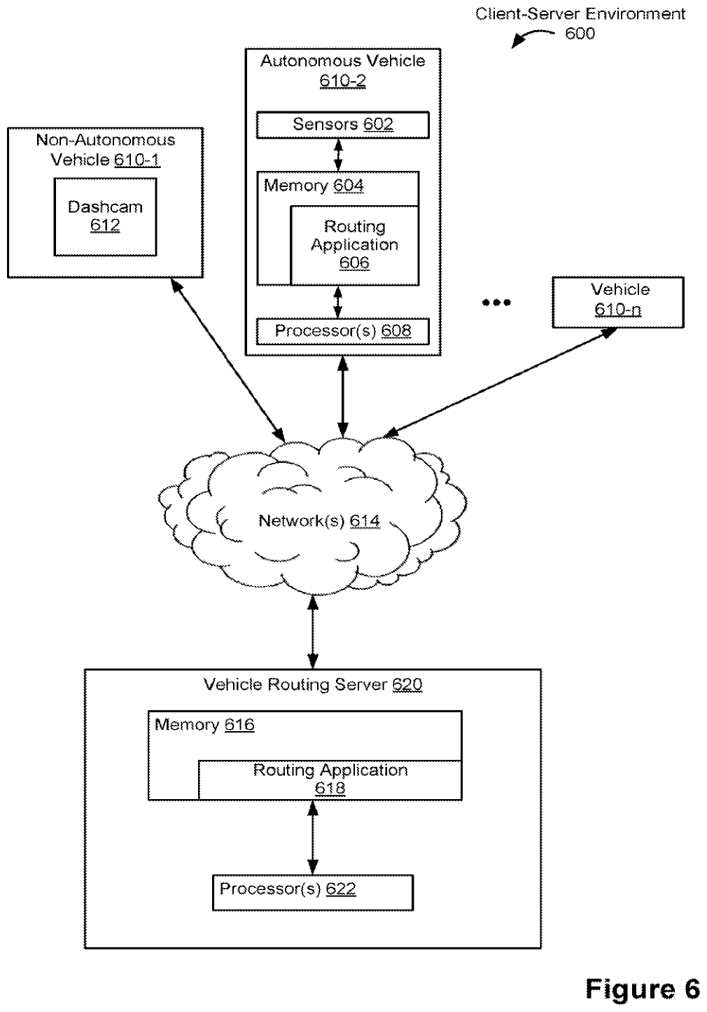

FIG. 6 is a block diagram illustrating a client-server environment 600, in accordance with some embodiments. The client-server environment 600 includes vehicles 610 (e.g., 610-1, 610-2, . . . , 610-n) that are connected to a vehicle routing server 620 through one or more networks 614. In some embodiments, vehicles 610 are or are analogous to vehicles 506 or 508 (shown in FIG. 5B). In some circumstances, the vehicles 610 operate as clients of vehicle routing server 620. The one or more networks 614 can be any network (or combination of networks) such as the Internet, other Wide Area Networks, Local Area Networks, metropolitan area networks, VPNs, peer-to-peer, ad-hoc connections, and so on.

The non-autonomous vehicle 610-1 is a representative human-driven vehicle (e.g., a car, truck, or motorcycle). In some embodiments, non-autonomous vehicle 610-1 is or is analogous to non-autonomous vehicle 506 (FIG. 5B). In some embodiments, non-autonomous vehicle 610 includes a dashboard camera 612 (e.g., dashboard camera 612) that acquires and sends camera images to vehicle routing server 620, which can automatically identify road conditions from the images captured by the dashboard camera 612 (as well as from autonomous vehicle camera sensor data from autonomous vehicles, such as from sensors 602 in an autonomous vehicle).

The autonomous vehicle 610-2 (e.g., a car, truck, motorcycle, delivery robot) includes non-transitory memory 604 (e.g., non-volatile memory) that stores instructions for one or more client routing applications 606. In some embodiments, autonomous vehicle 610-2 is or is analogous to autonomous vehicle 508 (FIG. 5B) Client routing applications 606 are executed by one or more processors (e.g., CPUs) 608 on the autonomous vehicle 610-2. In some embodiments, the client routing applications 606 send requests for routes to the vehicle routing server 620 and receive selected routes from the vehicle routing server 620. In some embodiments, the client routing applications 606 direct the autonomous vehicles 610-2 along the selected routes. Client routing applications 606 may be embodied as any appropriate combination of programs, firmware, operating systems, or other logical or physical aspects of the autonomous vehicle 610-2. Autonomous vehicle 610-2 also optionally includes one or more network interfaces and one or more communication buses for interconnecting these components. Autonomous vehicle 610-2 further includes vehicle components, such as an engine/motor, a steering mechanism, lights, signaling mechanisms, etc., some or all of which may be under the control of programs (e.g., a client routing application 606) stored in memory 604.

In some circumstances, a fleet of vehicles e.g., up to vehicle 610-n) is in communication with vehicle routing server 620. The fleet may be a mix of autonomous and human driven vehicles or may be entirely autonomous.

Vehicle routing server 620 includes non-transitory memory 616 (e.g., non-volatile memory) that stores instructions for one or more server routing applications 618 (sometimes referred to as “routing engines”). Vehicle routing server 620 further includes one or more processors (e.g., CPUs) 622 for executing server routing applications 618. Server routing applications 418 may be embodied as any appropriate combination of programs, firmware, operating systems, or other logical or physical aspects of the autonomous vehicle 610-2. Vehicle routing server 620 also optionally includes one or more network interfaces and one or more communication buses for interconnecting these components.

The above-identified applications correspond to sets of instructions for performing functions described herein. The applications need not be implemented as separate software programs, procedures, or modules, and thus various subsets of these instructions may be combined or otherwise re-arranged in various embodiments.

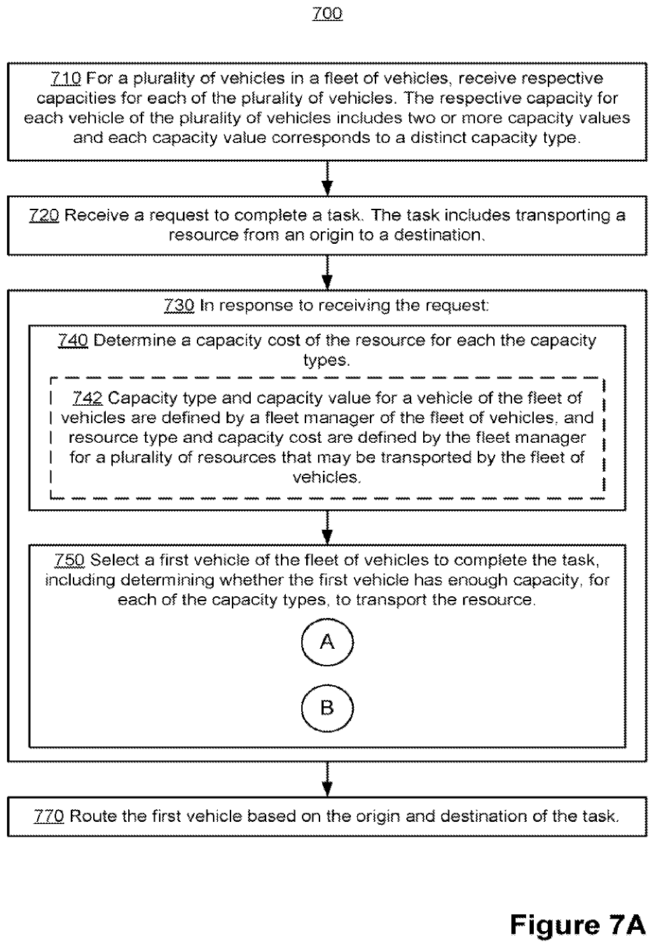

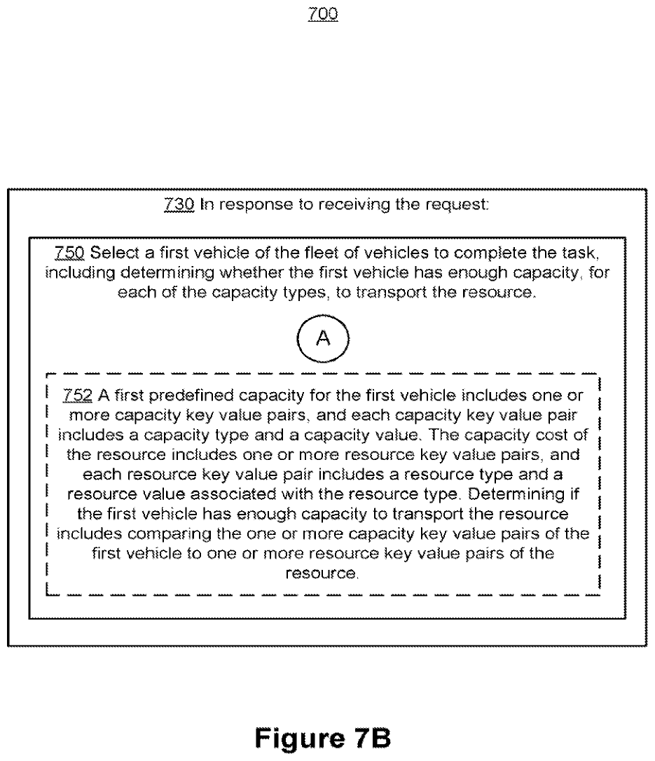

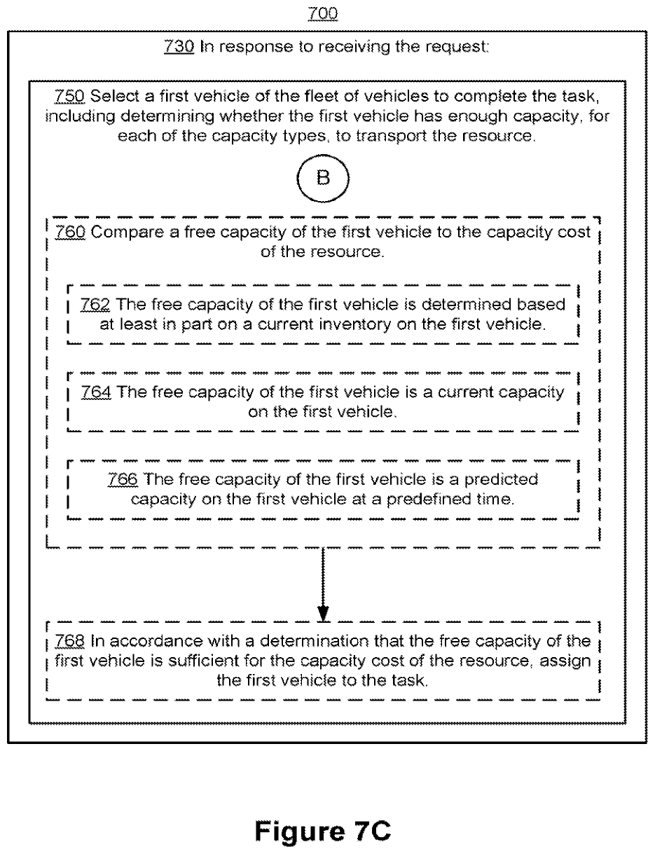

FIGS. 7A-7C illustrate a flowchart of a method 700 for modeling vehicle capacity and resources, in accordance with some embodiments. The method 700 includes, for a plurality of vehicles in a fleet of vehicles (e.g., vehicles 102 and 130 shown in FIGS. 1A and 1C, and delivery robots 202 and 230 shown in FIGS. 2A, 2C, and 20), receiving (710) (e.g., from a fleet manager) respective capacities for each of the plurality of vehicles. The respective capacity for each vehicle of the plurality of vehicles includes two or more capacity values (e.g., capacity values 108 shown in FIG. 1A and 208 shown in FIG. 2A) and each capacity value corresponds to a distinct capacity type (e.g., capacity types 106 shown in FIG. 1A and 206 shown in FIG. 2A). The method 700 also includes receiving (720) a request to complete a task (e.g., trip request 120 shown in FIG. 1C and trip request 220 shown in FIG. 2D), and in response (730) to receiving the request, determining (740) a capacity cost (e.g., required capacity) of the resource (e.g., inventory, item, asset, passenger) for each of the capacity types and selecting (750) (e.g., assigning, dispatching) a first vehicle of the fleet of vehicles to complete the task, including determining whether the first vehicle has enough capacity, for each of the capacity types, to transport the resource. The method 700 further includes routing (770) the first vehicle (e.g., the selected vehicle) based on the origin (e.g., pick-up location) and the destination (e.g., drop-off location) of the task. For example, the resource may be an item (e.g., a pizza), an asset from inventory (e.g., paper towels from grocery store), or passenger(s).

In some embodiments, the capacity type and capacity value (e.g., capacity value associated with the capacity type) for a vehicle of the fleet of vehicles are defined (742) by a fleet manager of the fleet of vehicles, and resource type and resource value (e.g., resource value associated with the resource type) are defined (742) by the fleet manager for a plurality of resources that may be transported by the fleet of vehicles.

In some embodiments, a first predefined capacity for the first vehicle includes one or more capacity key value pairs (e.g., key value pairs 104 and 204 shown in FIGS. 1A and 2A, respectively), and each capacity key value pair includes a capacity type (e.g., capacity types 106 and 206 shown in FIGS. 1A and FIG. 2A, respectively) and a capacity value (e.g., capacity values 108 and 208 shown in FIG. 1A and FIG. 2A, respectively). The capacity cost of the resource includes one or more resource key value pairs (e.g., key value pairs 112 and 212 shown in FIGS. 1A and 2A, respectively), and each resource key value pair includes a resource type (e.g., resource type 114 and 214 shown in FIGS. 1A and 2A, respectively) and a resource value (e.g., resource values 116 and 216, shown in FIG. 1A and FIG. 2A, respectively) associated with the resource type. Determining if the first vehicle has enough capacity to transport the resource includes comparing the one or more capacity key value pairs of the first vehicle to one or more resource key value pairs of the resource. An example of comparing the capacity of vehicles to the capacity cost of resources is shown in FIGS. 1C and 2D.

In some embodiments, the method 700 further includes, in response (730) to receiving the request (e.g., request to complete a task, such as trip requests 120 and 220 shown in FIGS. 1C and 2D), comparing (760) a free capacity (e.g., available capacity) of the first vehicle to the capacity cost of the resource. The method 700 also includes, in accordance with a determination that the free capacity of the first vehicle is sufficient for the capacity cost of the resource, assigning (768) the first vehicle to the task.

In some embodiments, the free capacity (e.g., available capacity) of the first vehicle is determined (762) based at least in part on a current inventory (e.g., inventory information 547) on the first vehicle.

In some embodiments, the free capacity (e.g., available capacity) of the first vehicle is (764) a current capacity on the first vehicle.

In some embodiments, the free capacity (e.g., available capacity) of the first vehicle is (766) a predicted capacity on the first vehicle at a predefined time (e.g., a pick-up time, in the future).

In some embodiments, the free capacity (e.g., available capacity) of the first vehicle is determined based at least in part on a predicted inventory on the first vehicle at the pick-up time. In some embodiments, the free capacity (e.g., available capacity) of the first vehicle is determined based at least in part on expected loads during the trip, for example, for ride-share trips that include a plurality of trips and at least one of the trips is already scheduled. In another example, a second resource for a second task is picked up prior to delivery of a first resource associated with a first trip. In such cases, determining free capacity (e.g., available capacity) includes identifying the capacity of the first vehicle prior to a current time or identifying a predicted capacity at a pick-up time.

In some embodiments, the resource has a capacity cost that includes two or more resource key value pairs. A first resource key value pair of the two or more resource key value pairs includes a first resource type and a first resource value, and a second resource key value pair of the two or more resource key value pairs includes a second resource type and a second resource value (e.g., key value pair 112-1 includes a resource type 114-1 and a resource value 116-1 that is associated with resource type 114-1). The second resource type is different from the first resource type (e.g., resource type 114-1 is a passenger and resource type 114-2 is a wheelchair). A first predefined capacity (e.g., maximum capacity) for the first vehicle includes a first capacity key value pair that includes a first capacity type and a first capacity value, and a second capacity key value pair that includes a second capacity type and a second capacity value (e.g., key value pair 104-1 includes a capacity type 106-1 and a capacity value 108-1 that corresponds to capacity type 106-1). The second capacity type is different from the first capacity type (e.g., capacity type 106-1 corresponds to passengers and is different from capacity type 106-2 which corresponds to wheelchairs). Determining if the first vehicle has enough capacity to transport the one or more resources, includes: (i) comparing the first resource value to the first capacity value, and (ii) comparing the second resource value to the second capacity value. The first capacity type is the same as the first resource type, and the second capacity type is the same as the second resource type. The method 700 also includes, in accordance with a determination that: i) the first capacity value (e.g., available capacity value) of the first vehicle is greater than or equal to the first resource value, and ii) the second capacity value (e.g., available capacity value) of the first vehicle is greater than or equal to the second resource value, assigning the first vehicle to the task.

In some embodiments, the method 700 includes receiving a first predefined capacity for vehicles of a first subset (e.g., a subset, less than all) of vehicles in the fleet of vehicles. The first subset of vehicles includes vehicles of a first type. The first predefined capacity includes one or more capacity types and a capacity value corresponding to each capacity type.

In some embodiments, the method 700 includes receiving a second predefined capacity for vehicles of a second subset (e.g., a subset, less than all) of vehicles in the fleet of vehicles. The second subset of vehicles include vehicles of a second type that is different from the first type. The second predefined capacity for vehicles of the second subset of vehicles includes one or more capacity types and a capacity value corresponding to each capacity type. The second predefined capacity is different from the first predefined capacity. For example, the first type of vehicle may be a small delivery robot and the second type of vehicle may be a delivery van.

In some embodiments, the first subset and the second subset of vehicles are non-overlapping. For example, vehicles included in the first subset of vehicles are not included in the second subset of vehicles and vice versa.

In some embodiments, the method 700 also includes dispatching the first vehicle to the origin and routing the first vehicle to the origin.

In some embodiments, routing the first vehicle is determined based on cost factors (e.g., cost function) such as estimated time of arrival, travel time, travel distance.

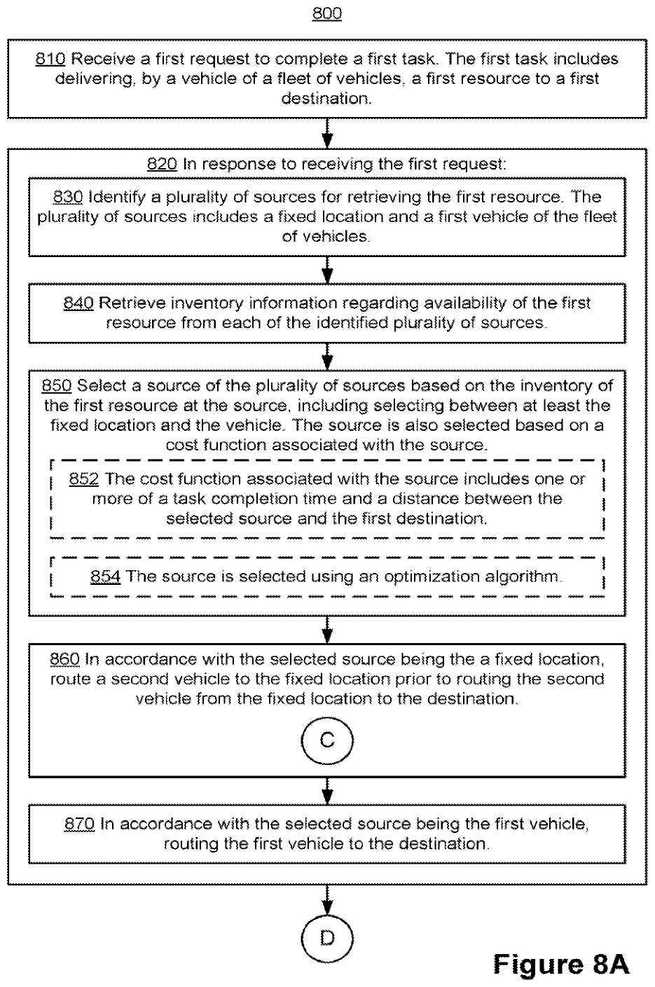

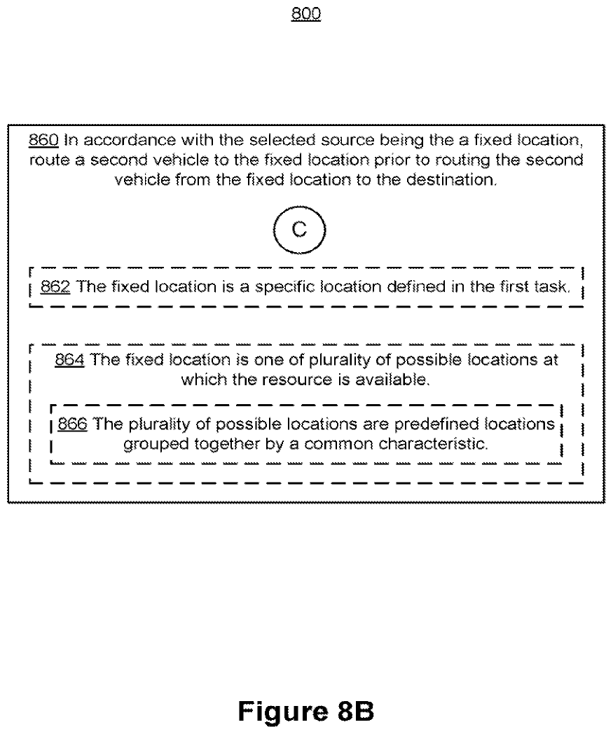

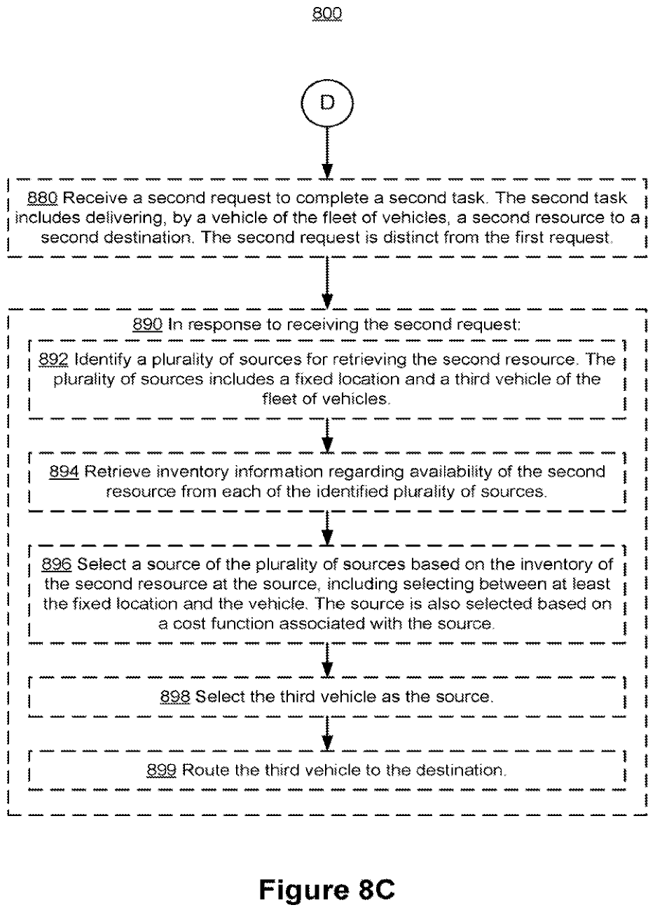

FIGS. 8A-8C illustrate a flowchart of a method 800 for inventory management, in accordance with some embodiments. The method 800 includes receiving (810) a first request 312 to complete a first task. The first task includes delivering (e.g., transporting), by a vehicle 314 of a fleet of vehicles, a first resource to a first destination. The method 800 also includes, in response (820) to receiving the first request, identifying (830) a plurality of sources for retrieving the first resource and retrieving (840) inventory information regarding availability of the first resource from each of the identified plurality of sources. Knowledge of inventory at each of the plurality of sources is required to retrieve the inventory information. The plurality of sources includes a fixed (e.g., stationary, not moving) location and a first vehicle 440 of the fleet of vehicles. The method 800 further includes, in response (820) to receiving the first request, selecting (850) a source of the plurality of sources based on the inventory of the first resource at the source, including selecting between at least the fixed location and the vehicle (e.g. one of the vehicles 440). The source is also selected based on a cost function associated with the source. The method 800 also includes, in accordance with the selected source being a fixed location, routing (860) a second vehicle 314 to the fixed location (e.g., location 420 or 430) prior to routing the second vehicle 314 from the fixed location to the destination. The method 800 further includes, in accordance with the selected source being the first vehicle 440-2, routing (870) the first vehicle 440-2 to the destination.

In some embodiments, the cost function associated with the source includes (852) one or more of a task completion time and a distance between the selected source and the first destination (e.g., a travel distance).

In some embodiments, the source is selected using (854) an optimization algorithm.

In some embodiments, the fixed location is (862) a specific location defined in the first task (e.g., defined in the request 312). In some embodiments, the specific location is defined by a user who submitted the request 312).

An example of a specific location 420 is provided with respect to FIG. 4A.

In some embodiments, the fixed location is one (864) of a plurality of possible locations at which the resource is available. An example is provided with respect to FIG. 4B.

In some embodiments, the plurality of possible locations are (866) predefined locations grouped together by a common characteristic. For example, the possible locations may be grocery stores. In another example, the possible locations are locations that are within a predetermined distance from a location (e.g., within 5 miles of a drop-off location).

In some embodiments, the method 800 includes receiving (880) a second request to complete a second task. The second task includes delivering, by a vehicle of the fleet of vehicles, a second resource to a second destination. The second request is distinct from (e.g., different from, separate from) the first request.

In some embodiments, the method further includes, in response (890) to receiving the second request, identifying (892) a plurality of sources for retrieving the second resource and retrieving (894) inventory information regarding availability of the second resource from each of the identified plurality of sources. The plurality of sources includes a fixed location and a third vehicle of the fleet of vehicles.

In some embodiments, the method also includes, in response (890) to receiving the second request, selecting (896) a source of the plurality of sources based on the inventory of the second resource at the source, including selecting between at least the fixed location and the vehicle. The source is also selected based on a cost function associated with the source.

In some embodiments, the method also includes, in response (890) to receiving the second request, selecting (898) the third vehicle as the source and routing (899) the third vehicle to the destination.

It will also be understood that, although the terms “first,” “second,” etc. are, in some circumstances, used herein to describe various elements, these elements should not be limited by these terms. These terms are only used to distinguish one element from another. For example, a first vehicle could be termed a second vehicle, and, similarly, a second vehicle could be termed a first vehicle, which changing the meaning of the description, so long as all occurrences of the “first vehicle” are renamed consistently and all occurrences of the second vehicle are renamed consistently. The first vehicle and the second vehicle are both vehicles, but they are not the same vehicle (e.g., the second vehicle is an additional vehicle).

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” is, optionally, construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative embodiments. For purposes of explanation, numerous specific details were set forth in order to provide an understanding of various embodiments of the inventive subject matter. It will be evident, however, to those skilled in the art that embodiments of the subject matter are, optionally, practiced without these specific details. In general, well-known instruction instances, protocols, structures and techniques have not been shown in detail.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best use the embodiments and various embodiments with various modifications as are suited to the particular use contemplated.

1. A method comprising:
for a plurality of vehicles in a fleet of vehicles, receiving respective capacities for each of the plurality of vehicles, wherein the respective capacity for each vehicle of the plurality of vehicles includes two or more capacity values, each capacity value corresponding to a distinct capacity type;
receiving a request to complete a task, wherein the task includes transporting a resource from an origin to a destination;
in response to receiving the request:
determining a capacity cost of the resource for each of the capacity types;
selecting a first vehicle of the fleet of vehicles to complete the task, including determining whether the first vehicle has enough capacity, for each of the capacity types, to transport the resource; and
routing the first vehicle based on the origin and destination of the task.

2. The method of claim 1, wherein selecting the first vehicle includes:
comparing a free capacity of the first vehicle to the capacity cost of the resource; and
in accordance with a determination that the free capacity of the first vehicle is sufficient for the capacity cost of the resource, assigning the first vehicle to the task.

3. The method of claim 2, wherein the free capacity of the first vehicle is determined based at least in part on a current inventory on the first vehicle.

4. The method of claim 2, wherein the free capacity of the first vehicle is a current capacity of the first vehicle.

5. The method of claim 2, wherein the free capacity of the first vehicle is a predicted capacity of the first vehicle at a predefined time.

6. The method of claim 1, wherein:
a first predefined capacity for the first vehicle includes one or more capacity key value pairs, each capacity key value pair including a capacity type and a capacity value;
the capacity cost of the resource includes one or more resource key value pairs, each resource key value pair including a resource type and a resource value associated with the resource type; and
determining if the first vehicle has enough capacity to transport the resource includes comparing the one or more capacity key value pairs of the first vehicle to one or more resource key value pairs of the resource.

7. The method of claim 1, wherein:
the resource has a capacity cost that includes two or more resource key value pairs;
a first resource key value pair of the two or more resource key value pairs includes a first resource type and a first resource value;
a second resource key value pair of the two or more resource key value pairs includes a second resource type and a second resource value, wherein the second resource type is different from the first resource type; and
a first predefined capacity for the first vehicle includes:
a first capacity key value pair that includes a first capacity type and a first capacity value; and
a second capacity key value pair that includes a second capacity type and a second capacity value, wherein the second capacity type is different from the first capacity type; and
determining if the first vehicle has enough capacity to transport the one or more resources, includes:
comparing the first resource value to the first capacity value, wherein the first capacity type is the same as the first resource type; and
comparing the second resource value to the second capacity value, wherein the second capacity type is the same as the second resource type; and
the method further includes, in accordance with a determination that: i) the first capacity value is greater than or equal to the first resource value and ii) the second capacity value is greater than or equal to the second resource value, assigning the first vehicle to the task.

8. The method of claim 1, further comprising:
receiving a first predefined capacity for vehicles of a first subset of vehicles in the fleet of vehicles, the first subset of vehicles including vehicles of a first type, wherein the first predefined capacity includes one or more capacity types and a capacity value corresponding to each capacity type; and
receiving a second predefined capacity for vehicles of a second subset of vehicles in the fleet of vehicles, the second subset of vehicles including vehicles of a second type that is different from the first type, wherein:
the second predefined capacity for vehicles of the second subset of vehicles includes one or more capacity types and a capacity value corresponding to each capacity type; and
the second predefined capacity is different from the first predefined capacity.

9. The method of claim 1, wherein:
capacity type and capacity value for a vehicle of the fleet of vehicles are defined by a fleet manager of the fleet of vehicles; and
resource type and resource value are defined by the fleet manager for a plurality of resources that may be transported by the fleet of vehicles.

10-11. (canceled)

12. A method comprising:
receiving a first request to complete a first task, wherein the first task includes delivering, by a vehicle of a fleet of vehicles, a first resource to a first destination;
in response to receiving the first request:
identifying a plurality of sources for retrieving the first resource, the plurality of sources including a fixed location and a first vehicle of the fleet of vehicles;
retrieving inventory information regarding availability of the first resource from each of the identified plurality of sources;
selecting a source of the plurality of sources based on the inventory of the first resource at the source, including selecting between at least the fixed location and the vehicle, wherein the source is also selected based on a cost function associated with the source;
in accordance with the selected source being the fixed location, routing a second vehicle to the fixed location prior to routing the second vehicle from the fixed location to the destination; and
in accordance with the selected source being the first vehicle, routing the first vehicle to the destination.

13. The method of claim 12, wherein the fixed location is a specific location defined in the first task.

14. The method of claim 12, wherein the fixed location is one of a plurality of possible locations that the resource is available.

15. The method of claim 14, wherein the plurality of possible locations are predefined locations grouped together by a common characteristic.

16. The method of claim 12, wherein the cost function associated with the source includes one or more of a task completion time and a distance between the selected source and the first destination.

17. The method of claim 12, wherein the source is selected using an optimization algorithm.

18. The method of claim 12, wherein the selected source for the first task is the fixed location, and the method further comprises:
receiving a second request to complete a second task, wherein the second task includes delivering, by a vehicle of the fleet of vehicles, a second resource to a second destination, the second request being distinct from the first request;
in response to receiving the second request:
identifying a plurality of sources for retrieving the second resource, the plurality of sources including a fixed location and a third vehicle of the fleet of vehicles;
retrieving inventory information regarding availability of the second resource from each of the identified plurality of sources;
selecting a source of the plurality of sources based on the inventory of the second resource at the source, including selecting between at least the fixed location and the vehicle, wherein the source is also selected based on a cost function associated with the source;
selecting the third vehicle as the source; and
routing the third vehicle to the destination.

19-20. (canceled)

21. A non-transitory, computer readable medium storing instructions that, when executed by a computer system having one or more processors, cause the computer system to:
for a plurality of vehicles in a fleet of vehicles, receive respective capacities for each of the plurality of vehicles, wherein the respective capacity for each vehicle of the plurality of vehicles includes two or more capacity values, each capacity value corresponding to a distinct capacity type;
receive a request to complete a task, wherein the task includes transporting a resource from an origin to a destination;
in response to receiving the request:
determine a capacity cost of the resource for each of the capacity types;
select a first vehicle of the fleet of vehicles to complete the task, including determining whether the first vehicle has enough capacity, for each of the capacity types, to transport the resource; and
route the first vehicle based on the origin and destination of the task.

22. The non-transitory, computer readable medium of claim 21, wherein the instruction cause the computer system to:
compare a free capacity of the first vehicle to the capacity cost of the resource; and
in accordance with a determination that the free capacity of the first vehicle is sufficient for the capacity cost of the resource, assign the first vehicle to the task.

23. The non-transitory, computer readable medium of claim 21, wherein:
the resource has a capacity cost that includes two or more resource key value pairs;
a first resource key value pair of the two or more resource key value pairs includes a first resource type and a first resource value;
a second resource key value pair of the two or more resource key value pairs includes a second resource type and a second resource value, wherein the second resource type is different from the first resource type; and
a first predefined capacity for the first vehicle includes:
a first capacity key value pair that includes a first capacity type and a first capacity value; and
a second capacity key value pair that includes a second capacity type and a second capacity value, wherein the second capacity type is different from the first capacity type; and
determining if the first vehicle has enough capacity to transport the one or more resources, includes:
comparing the first resource value to the first capacity value, wherein the first capacity type is the same as the first resource type; and
comparing the second resource value to the second capacity value, wherein the second capacity type is the same as the second resource type; and
wherein, in accordance with a determination that: i) the first capacity value is greater than or equal to the first resource value and ii) the second capacity value is greater than or equal to the second resource value, the instructions further cause the computer system to assign the first vehicle to the task.

24. The non-transitory, computer readable medium of claim 21, wherein the instructions further cause the computer system to:
receive a first predefined capacity for vehicles of a first subset of vehicles in the fleet of vehicles, the first subset of vehicles including vehicles of a first type, wherein the first predefined capacity includes one or more capacity types and a capacity value corresponding to each capacity type; and
receive a second predefined capacity for vehicles of a second subset of vehicles in the fleet of vehicles, the second subset of vehicles including vehicles of a second type that is different from the first type, wherein:
the second predefined capacity for vehicles of the second subset of vehicles includes one or more capacity types and a capacity value corresponding to each capacity type; and
the second predefined capacity is different from the first predefined capacity.
